(19) United States
(12) Patent Application Publication
(10) Pub. No.: US 2014/0003077 A1
(43) Pub. Date: Jan. 2, 2014

(54) Light Module for Vehicle

(71) Applicant: Kwun Wah Chan, Walnut, CA (US)

(72) Inventor: Kwun Wah Chan, Walnut, CA (US)

(21) Appl. No.: 13/534,017

(22) Filed: Jun. 27, 2012

(51) Int. Cl. B60Q 1/00; F21V 7/00; F21V 9/16

(52) U.S. Cl. 362/516; 362/509; 362/543

(57) ABSTRACT

A light module includes a solid light frame and a light source embedded in the light frame, wherein the light source includes two spaced conductive films, a plurality of conductive terminals, and a plurality of light emitters. The conductive films are embedded at a bottom side of the light frame. The conductive terminals are implanted into the light frame, wherein each of the conductive terminals is conducted with one of the conductive films. The light emitters are implanted into an upper portion of the light frame, wherein the light emitters are conducted with the conductive terminals respectively. The conductive terminals are distributed at the light frame to generate a uniform light effect along the light frame when the conductive terminals are electrified.

### BACKGROUND

1. Field of the Invention

The present invention relates to a vehicle light assembly. More particularly, the present invention relates to a light module for a vehicle, which is a rigid, non-fragile, compact, and LED-like module to generate a uniform light effect.

2. Discussion of the Related Art

It is conventional to provide the exterior of a vehicle with lighting devices. Halogen light is generally utilized in vehicle light system including tail light, brake light, stop light, etc. The halogen light generally comprises a replaceable halogen bulb plugged into a bulb socket. The halogen bulb is made of a sealed glass tube filled within an inert gas and a small of halogen gas, and a filament received in the glass tube, wherein the halogen bulb can produce a high intensity light and a uniform light effect along the glass tube. However, the halogen bulb will generate heat. Because the halogen light operates at very high temperatures, the vehicle light system must incorporate with some sorts of heat insulated structure to prevent burn hazards. The disadvantages of the halogen light are that the life cycle of the halogen bulb is short, the glass tube is too fragile that the glass tube requires special handling and packaging, and the halogen bulb is energy consuming.

Cold-cathode fluorescent lamp (CCFL) is another common light module used for vehicle light system, wherein CCFL uses a discharge in mercury vapor to develop ultraviolet light, which in turn causes a fluorescent coating on the inside of the glass tube to emit visible light. Similar to the halogen light, CCFL can produce a high intensity light and a uniform light effect along the glass tube. The energy efficiency and the life cycle of CCFL are better than the energy efficiency and the life cycle of halogen light. However, the glass tube is also too fragile that the glass tube requires special handling and packaging. Cold starts and low temperature performance are also the disadvantages of the CCFL. The shape of CCFL is also limited by its glass tube.

LED light modules are one of the most popular enthusiasts do to the vehicle light system. The LED light module generally comprises a plurality of spaced LEDs affixed on a light base. The main advantages of LED light modules are high energy efficiency, extremely long service life, and low heat generation comparing with halogen light and CCFL. The LED light modules have good environmental performance including high temperature and high humidity resistance. Because each LED comprises a solidstate chip embedded in epoxy, each LED is hard to break or burn out. Because the LEDs are spaced apart each other, the LED light module can only produce a plurality of spot lights but not produce an uniform light effect. Therefore, people will see lots of bright dots at the LED light module.

### BRIEF SUMMARY OF THE INVENTION

The present invention overcomes the above mentioned drawbacks and limitation by incorporating a light module for a vehicle, which is a simple, compact and inexpensive device.

The primary objective of the present invention is that the light module is a rigid, non-fragile, compact, and CCFL-like module to generate a uniform light effect, wherein no bright dot will be seen as the conventional LED light module.

Another objective of the present invention is that the light module can be configured to any shape, such as a ring shape to generate a prefect circular uniform light effect.

Another objective of the present invention is that the light module is designed to be user-friendly. The light module is readily available, and inexpensive in manufacturing cost. Advantages include a requirement of very small power consumption, ease of installation, and extremely thin structure.

Another objective of the present invention is that the light module contains the advantages of high energy efficiency, extremely long service life, and low heat generation.

Another objective of the present invention is that the light module is compatible with any CCFL light for vehicle.

The light module of the instant invention comprises a solid light frame and a light source embedded in the light frame, wherein the light source is entirely protected by the light frame.

The light source comprises at least two spaced conductive films, a plurality of conductive terminals, and a plurality of light emitters.

The conductive films are embedded at a bottom side of the light frame, wherein the conductive films do not intersect with each other to form a gap therebetween and being filled by the light frame.

The conductive terminals are implanted into the light frame, wherein each of the conductive terminals is conducted with one of the conductive films.

The light emitters are implanted into an upper portion of the light frame, wherein the light emitters are conducted with the conductive terminals respectively. The conductive terminals are distributed at the light frame to generate a uniform light effect along the light frame when the conductive terminals are electrified.

Specifically, each of the light emitters is a diode, wherein each of the light emitters comprises a positive terminal, negative terminal located aside the positive terminal, and a conductor die located between the positive terminal and the negative terminal. Most importantly, the positive terminal, negative terminal, and conductor die are embedded at the same level of the upper portion of the light frame so that the space required for placing the light emitter will be significantly reduced. The thickness of the light frame can be significantly minimized. The conductive terminals are formed in pair and are electrically conducted with the positive terminal and negative terminal of the light emitter respectively. The light emitters are positioned close enough to generate the uniform light effect.

For a more complete understanding of the present invention with its objectives and distinctive features and advantages, reference is now made to the following specification and to the accompanying drawings.

### BRIEF DESCRIPTION OF THE DRAWING(S)

FIG. 1 is a schematic view of a light module for a vehicle in accordance with the presently embodiment of the invention.

FIG. 2 is a first sectional view of the light module in accordance with the presently embodiment of the invention.

FIG. 3 is a second sectional view of the light module in accordance with the presently embodiment of the invention.

FIG. 4 is shows an alternative shape of the light module in accordance with the presently embodiment of the invention.

### DETAILED DESCRIPTION OF THE INVENTION

In accordance with a preferred embodiment of the present invention, the present invention provides a light module 100 replaceably mounted at a light casing 200 which is mounted to a vehicle to electrically connect the light module 100 to a power source of the vehicle. The light module 100 of the invention can be utilized as the lighting system of the exterior of the vehicle such as tail light, brake light, stop light, etc. The light module 100 of the invention can form the decorative light for the vehicle.

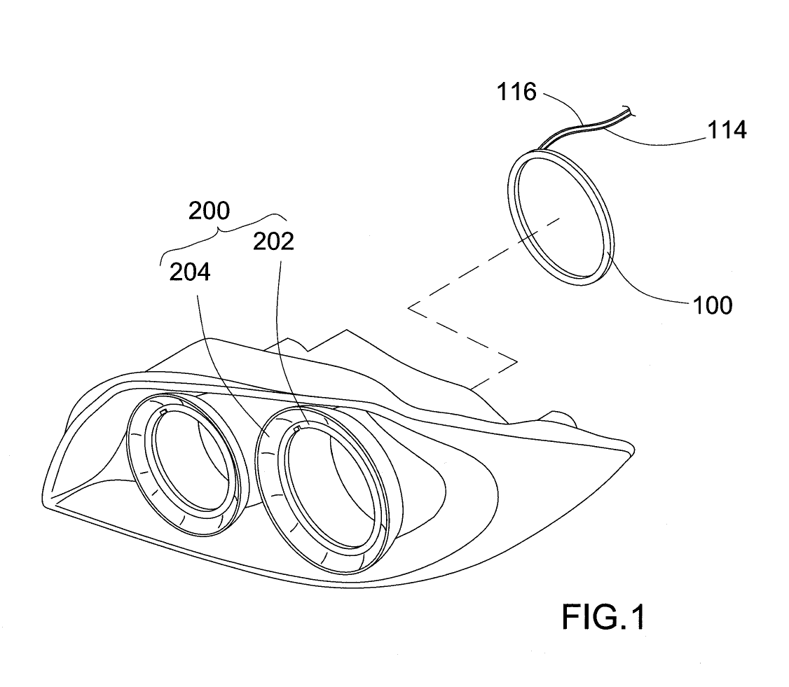

FIGS. 1 to 3 depict the light module 100 as a presently embodiment, wherein the light module 100 comprises a light frame 102 and a light source 104 embedded in the light frame 102. Therefore, the light source 104 is entirely protected by the light frame 102.

In the presently embodiment, the light frame 102 is made of insulated material and is constructed in a non-hollow configuration so that the light source 104 is entirely embedded and protected by the light frame 102. It is preferred that the light frame 102 is made of epoxy and the thickness of the light frame 102 is lesser than 3 mm.

The light frame 102 is preferred to be made by mold injection so that the shape of the light frame 102 can be altered. In FIG. 1, the light frame 102 is configured to have a ring shape. It is preferred that the top and bottom sides of the light frame 102 are two flat surfaces.

In the presently embodiment, the light source 104 comprises at least two spaced conductive films 106 and 108, a plurality of conductive terminals 110, and a plurality of light emitters 112.

The conductive films 106 and 108 are embedded at a bottom side of the light frame 102, wherein the conductive films 106 and 108 do not intersect with each other to form a gap therebetween and being filled by the light frame 102.

The conductive films 106 and 108 are two thin conductive layers embedded at the bottom side of the light frame 102, wherein the conductive films are extended space apart, so that gap is formed between the conductive films 106 and 108. Because the conductive films 106 and 108 are embedded in the light frame 102, a portion of the light frame 102 is filled at the gap to separate the conductive films 106 and 108 to prevent the conductive films 106 and 108 contacting with each other.

The conductive terminals 110 are implanted into the light frame 102, wherein each of the conductive terminals 110 is conducted with one of the conductive films 106 and 108. The conductive terminals 110 are formed in pair as positive and negative conductive terminals to electrically conduct with the conductive films 106 and 108 respectively to electrify the light emitters 112.

The conductive terminals 110 are embedded a mid-portion of the light frame 102, wherein the bottom portion of each of the conductive terminals 110 is conducted with the corresponding conductive film 106 or 108. The upper portion of the conductive terminal 110 is conducted with the corresponding light emitter 112.

In FIG. 1, the light module 100 is formed in a ring shape for use in a headlamp of the vehicle. That is to say, the light frame 102 is configured in a ring shape to define an inner ring portion and an outer ring portion, wherein the conductive terminals 110 are spaced at the inner ring portion and the outer ring portion of the light frame 102. That is to say, the positive terminal and the negative terminal are located at the inner ring portion and the outer ring portion of the light frame 102. The conductive films 106 and 108 form an inner ring film and an outer ring film embedded at the inner ring portion and the outer ring portion of the light frame 102 respectively to electrically conduct with the conductive terminals 110. The light emitters 112 are radially embedded at the upper portion of the ring shaped light frame 102. Therefore, when the light emitters 112 are electrified, the light emitters 112 will generate a perfect circular uniform light effect to provide the most aesthetically appealing appearance. Unlike the CCFL, the glass tube of CCFL cannot be bent in a ring shape, wherein the glass tube of CCFL can only be bent in imperfect circular shape with an opening gap between two ends so that CCFL cannot generate the perfect circular uniform light effect as illustrated in the invention.

The light emitters 112 are implanted into an upper portion of the light frame 102, wherein the light emitters 112 are conducted with the conductive terminals 110 respectively. The light emitters 112 are configured as the thin conductive filaments transversely embedded in the light frame 102, wherein the light emitters 112 are located above the conductive films 106 and 108 that each of the light emitters 112 is projected to across the conductive films 106 and 108. For the ring shaped light frame 102, the light emitters 112 are radially extended from the upper portion of the light frame 102 and is extended from the inner ring portion of the light frame 102 to the outer ring portion thereof.

In the presently embodiment, the light emitters 112 are a plurality of diodes transversely embedded at the upper portion of the light frame 102 and are electrically conducted with the conductive films 106 and 108 though pairs of the conductive terminals 110.

Specifically, each of the light emitters 112 is a diode, wherein each of the light emitters 112 comprises a positive terminal 112A, negative terminal 112B located aside the positive terminal 112A, and a conductor die 112C located between the positive terminal 112A and the negative terminal 112B. Most importantly, the positive terminal 112A, the negative terminal 112B, and the conductor die 112C are embedded at the same level of the upper portion of the light frame 102 so that the space required for placing the light emitter 112 will be significantly reduced. The thickness of the light frame 102 can be significantly minimized. The conductive terminals 110 are formed in pair and are electrically conducted with the positive terminal 112A and negative terminal 1128 of the light emitter 112 respectively.

The conductor dies 112C of the light emitters 112 are aligned at a centerline of the top side of the light frame 102 and are positioned close to the top side of the light frame 102. The light emitters 112 are positioned close enough that the light projection angles of the light emitters 112 overlaps with each other to generate the uniform light effect similar to the CCFL light effect. Therefore, there is no bright dot to be seen along the light frame 102 when the light emitters 112 are electrified to generate light.

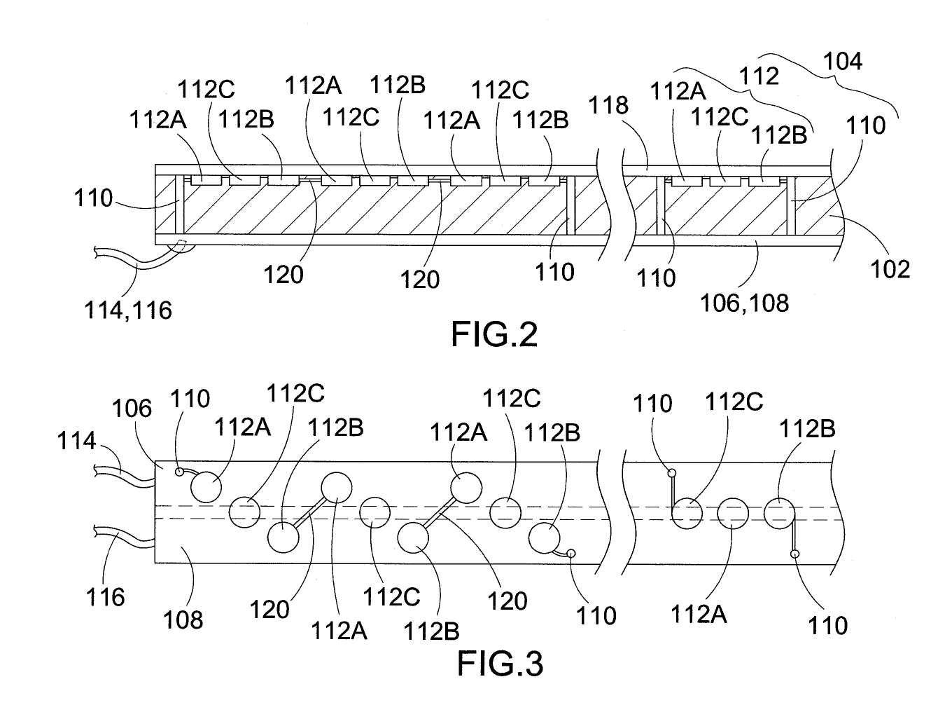

The light source 104 further comprises a plurality of conductive threads 120 electrically linked with the light emitters 112, wherein the conductive threads 120 are conductive filaments embedded at the upper portion of the light frame 102. A predetermined numbers of the light emitters 112 are grouped by the conductive threads 120 to electrically conduct with the pair of the conductive terminals 110. In each group, the light emitters 112 are electrically linked by the conductive threads 120 in series connection. Therefore, numbers of conductive terminals 110 can be reduced because each pair of conductive terminals 110 can electrically conduct with more than two light emitters 112 in a group. FIGS. 2 and 3 illustrate three light emitters 112 are grouped to electrically conduct with one pair of conductive terminals 110. FIGS. 2 and 3 further illustrate only one light emitter 112 is electrically conduct with one pair of conductive terminals 110.

The ring-shaped light frame 102 has the dimension as follow: The thickness of the light frame 102 is not more than 4 mm, preferably lesser than 3 mm. The outer diameter of the light frame 102 is about 10 cm. The width of the light frame 102 is about 5 mm. There are more than 100 light emitters 112 being embedded at the upper portion of the light frame 102.

In the presently embodiment, the light source 104 further comprises a connection means for connecting the conductive terminals 110 with the power source of the vehicle. The connecting means comprises two connection cables 114 and 116 connecting to the conductive films 106 and 108 respectively.

One end of each of the connection cables 114 and 116 are affixed to the bottom side of the light frame 102 by glue to retain the connection of the cable end of the connection cable 114 and 116 and to prevent the disconnection of the connection cable 114 and 116 by a pulling force. Specifically, the cable ends of the connection cables 114 and 116 are embedded in the bottom side of the light frame 102 to connect with the conductive films 106 and 108 respectively.

The light module further comprises a light diffusing layer 118 embedded at the top side of the light frame 102 to diffuse the light from the light emitters 112 and to enhance the uniform light effect along the light frame 102. The light diffusing layer 118 is also formed in a corresponding ring shape matching with the ring shaped light frame 102. It is preferred that the light diffusing layer 118 is also made of fluorescent material to enhance the light intensity of the light source 104.

In the presently embodiment, the light casing 200 comprises a flat mounting surface 202 to couple with the bottom side of the light frame 102 and a light reflective surface 204 projected from the mounting surface 202 for reflecting the light from the light source 104.

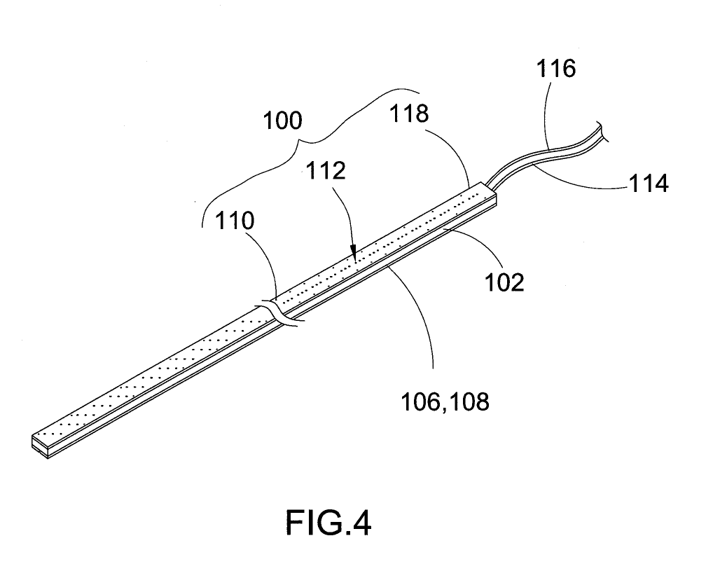

It should be appreciated that the light module 100 can be formed in an elongated strip as in FIG. 4, wherein the light frame 102 is constructed in a non-hollow configuration to define two longitudinal portions. The conductive terminals 110 are spaced at the longitudinal portions of the light frame 102. The conductive films 106 and 108 are elongated conductive films embedded at the longitudinal portions of the light frame 102 respectively to electrically conduct with the conductive terminals 110.

The light emitters 112 are transversely embedded in the light frame 102, wherein the positive terminal 112A and the negative terminal 112B are positioned at the longitudinal portions of the light frame 102 respectively to electrically conduct with the conductive terminals 110, wherein the conductor die 112C is located between the positive terminal 112A and the negative terminal 112B. The positive terminal 112A, the negative terminal 112B, and the conductor die 112C are embedded at the same level of the upper portion of the light frame 102.

It should be appreciated that the light frame 102 can be configured in any shape without any limitation of the light emitters 112. Because the light emitters 112 are embedded in the light frame 102, the light module 100 of the invention can be formed at any shape, even the irregular shape, such as symbol shape, numerical shape or alphabetical shape, to provide the uniform light effect.

While the embodiments and alternatives of the invention have been shown and described, it will be apparent to one skilled in the art that various other changes and modifications can be made without departing from the spirit and scope of the invention.

What is claimed is:

1. A light module for a vehicle, comprising:
a solid light frame; and
a light source embedded in said light frame, which comprise:
at least two spaced conductive films embedded at a bottom side of said light frame, wherein said conductive films do not intersect with each other;
a plurality of conductive terminals implanted into said light frame, wherein each of said conductive terminals is conducted with one of said conductive films; and
a plurality of light emitters implanted into an upper portion of said light frame, said light emitters being conducted with said conductive terminals respectively and being distributed at said light frame to generate a uniform light effect along said light frame when said light emitters are electrified.

2. The light module of claim 1 wherein each of said light emitters comprises a positive terminal, negative terminal located aside said positive terminal, and a conductor die located between said positive terminal and said negative terminal, wherein said positive terminal, negative terminal, and conductor die are embedded at the same level of said upper portion of said light frame, wherein said conductive terminals are formed in pair and are electrically conducted with said positive terminal and negative terminal of said light emitter respectively.

3. The light module of claim 2 wherein said light source further comprises a plurality of conductive threads embedded at said upper portion of said light frame, wherein a predetermined number of said light emitters are connected to form a group by said conductive threads, wherein each group of said light emitters is electrically conducted with said pair of said conductive terminals.

4. The light module of claim 1 wherein said conductive terminals are embedded in said light frame, wherein a bottom portion of each of said conductive terminals is conducted with said corresponding conductive film, wherein an upper portion of said conductive terminal is conducted with said corresponding light emitter.

5. The light module of claim 3 wherein said conductive terminals are embedded in said light frame, wherein a bottom portion of each of said conductive terminals is conducted with said corresponding conductive film, wherein an upper portion of said conductive terminal is conducted with said corresponding light emitter.

6. The light module of claim 1 wherein said conductive films are two thin conductive layers embedded at said bottom side of said light frame and extended spaced apart, wherein a gap is formed between said conductive films, wherein a portion of said light frame is filled at said gap to separate said conductive films.

7. The light module of claim 5 wherein said conductive films are two thin conductive layers embedded at said bottom side of said light frame and formed in parallel, wherein a gap is formed between said conductive films, wherein a portion of said light frame is filled at said gap to separate said conductive films.

8. The light module of claim 1 wherein said light frame is made of insulated material and is constructed in a non-hollow configuration so that said light source is entirely embedded and protected by said light frame.

9. The light module of claim 7 wherein said light frame is made of insulated material and is constructed in a non-hollow configuration so that said light source is entirely embedded and protected by said light frame.

10. The light module of claim 1 wherein the thickness of said light frame is lesser than 3 mm.

11. The light module of claim 9 wherein the thickness of said light frame is lesser than 3 mm.

12. The light module of claim 1 wherein said light source further comprises a connection means for connecting said conductive terminals with a power source of said vehicle, wherein said connecting means comprises two connection cables connecting to said conductive films respectively, ends of said connection cables being affixed to and embedded in said bottom side of said light frame to connect with said conductive films respectively.

13. The light module of claim 11 wherein said light source further comprises a connection means for connecting said conductive terminals with a power source of said vehicle, wherein said connecting means comprises two connection cables connecting to said conductive films respectively, ends of said connection cables being affixed to and embedded in said bottom side of said light frame to connect with said conductive films respectively.

14. The light module of claim 1 further comprising a light diffusing layer embedded at a top side of said light frame to diffuse the light from said light emitters and to enhance said uniform light effect along said light frame, wherein said light diffusing layer is also made of fluorescent material to enhance the light intensity of said light source.

15. The light module of claim 13 further comprising a light diffusing layer embedded at a top side of said light frame to diffuse the light from said light emitters and to enhance said uniform light effect along said light frame, wherein said light diffusing layer is also made of fluorescent material to enhance the light intensity of said light source.

16. The light module of claim 1 further comprising a light casing for housing said light frame, wherein said light casing comprises a flat mounting surface to couple with said bottom side of said light frame and a light reflective surface projected from said mounting surface for reflecting the light from said light source.

17. The light module of claim 15 further comprising a light casing for housing said light frame, wherein said light casing comprises a flat mounting surface to couple with said bottom side of said light frame and a light reflective surface projected from said mounting surface for reflecting the light from said light source.

18. The light module of claim 1 wherein said light frame is configured in a ring shape, wherein said conductive terminals are spaced at an inner ring portion and an outer ring portion of said light frame, wherein said light emitters are radially embedded at said upper portion of said light frame to generate a perfect circular uniform light effect.

19. The light module of claim 17 wherein said light frame is configured in a ring shape, wherein said conductive terminals are spaced at an inner ring portion and an outer ring portion of said light frame, wherein said light emitters are radially embedded at said upper portion of said light frame to generate a perfect circular uniform light effect.

20. The light module of claim 18 wherein said conductive films form an inner ring film and an outer ring film embedded at said inner ring portion and said outer ring portion of said light frame respectively.

21. The light module of claim 19 wherein said conductive films form an inner ring film and an outer ring film embedded at said inner ring portion and said outer ring portion of said light frame respectively.
